(19) United States
(12) Patent Application Publication
(10) Pub. No.: US 2025/0230005 A1
(43) Pub. Date: Jul. 17, 2025

(54) MEDIUM TRANSPORT DEVICE AND RECORDING DEVICE

(71) Applicant: SEIKO EPSON CORPORATION, Tokyo (JP)

(72) Inventors: Ryuichi SATO, SHIOJIRI-SHI (JP); Naohiro UEYAMA, MATSUMOTO-SHI (JP)

(21) Appl. No.: 19/024,862

(22) Filed: Jan. 16, 2025

(30) Foreign Application Priority Data
Jan. 16, 2024 (JP) 2024-004391

(51) Int. Cl. B65H 5/06; B65H 23/26

(52) U.S. Cl. CPC B65H 5/068; B65H 23/26; B65H 2404/14

(57) ABSTRACT

The medium transport device 6 includes a feed out section 2 that feeds out the medium 3 that is wound into a roll shape, a main roller 8 that applies a feeding force to the medium in the transport direction F, and sub rollers 9 that pair with the main roller to rotate while nipping the medium therebetween, wherein the sub rollers 9 are a plurality of rollers including a first roller 91, a second roller 92, a third roller 93, . . . , and an n-th roller arranged at a distance D from each other along the longitudinal direction of the main roller 8, the distance D includes a first distance D1 and a second distance D2 that is larger than the first distance.

The present application is based on, and claims priority from JP Application Serial Number 2024-004391, filed Jan. 16, 2024, the disclosure of which is hereby incorporated by reference herein in its entirety.

### BACKGROUND

### 1. Technical Field

The present disclosure relates to a medium transport device and a recording device.

### 2. Related Art

An example of this type of device is the printing device described in JP-A-2016-182716. JP-A-2016-182716 describes the following.

A transport roller pair and a paper feed roller pair constitute a transport section for transporting a medium such as cut paper or roll paper.

In order to transport the medium, it is preferable that the pair of transport rollers and the pair of paper feed rollers are a pair of rollers extending as a single continuous roller in the width direction.

However, since the cost is high and it is not easy to obtain the parallelism of the other roller with respect to one roller, the other roller is usually constituted by a plurality of rollers.

However, in such a configuration, there is a difference in the transport force exerted on the medium between nip portions and non-nip portions by both of the rollers. When the directions of the plurality of rollers on the other side are shifted from each other, variation occurs in the transport direction, and skew occurs. As a result, when the medium to be transported has low rigidity such as fabric, wrinkles may occur in the medium. In particular, wrinkles became concentrated in narrow areas such as between multiple rollers. When the wrinkles become concentrated in a narrow portion of the width, there is a possibility that creases will form in the medium. However, there is no description in JP-A-2016-182716 that considers the occurrence of the above-mentioned wrinkles.

### SUMMARY

In order to solve the above problem, a medium transport device according to the present disclosure includes a feed out section that feeds out a medium that is wound into a roll shape, a main roller that applies a feeding force to the medium in a transport direction, and sub rollers that pair with the main roller to rotate while nipping the medium therebetween, wherein the sub rollers are a plurality of rollers including a first roller, a second roller, a third roller, . . . , and an n-th roller arranged at distances from each other along the longitudinal direction of the main roller, Here, n is an integer of 3 or more, and the distances are a first distance and a second distance that is larger than the first distance.

A recording device according to the present disclosure includes the medium transport device according to any one of the first to fourth aspects and a recording section that performs recording on the medium transported by the medium transport device.

### BRIEF DESCRIPTION OF THE DRAWINGS

FIG. 1 is an entire side view and an enlarged view of a main portion of a recording device according to a first embodiment.

FIG. 2 is a perspective view of a main portion of the recording device according to the first embodiment.

FIG. 3 is a view showing a portion of a main roller of the recording device according to the first embodiment.

FIG. 4 is a view showing a portion of a sub roller of the recording device according to the first embodiment.

FIG. 5 is a view showing a portion of a sub roller of the recording device according to the first embodiment.

FIG. 6 is a view for explaining how the wrinkle is occurred by the distance D1 and the distance D2.

FIG. 7 is a view for explaining a modification of the first embodiment.

FIG. 8 is a view showing a portion of main roller of the recording device according to the second embodiment.

FIG. 9 is a view showing a portion of main roller of the recording device according to the second embodiment.

### DESCRIPTION OF EMBODIMENTS

The present disclosure will be first schematically described below. A medium transport device according to a first aspect of the disclosure includes a feed out section that feeds out a medium that is wound into a roll shape, a main roller that applies a feeding force to the medium in a transport direction, and sub rollers that pair with the main roller to rotate while nipping the medium therebetween, wherein the sub rollers are a plurality of rollers including a first roller, a second roller, a third roller, . . . , and an n-th roller arranged at distances from each other along the longitudinal direction of the main roller, n being an integer equal to or larger than 3, and the distance has a first distance and a second distance that is larger than the first distance.

The sub rollers are a plurality of rollers including a first roller, a second roller, a third roller, . . . , and an n-th roller (where n is an integer equal to or larger than 3), arranged at distances from each other along the longitudinal direction of the main roller. If there is variation in the transport force or the transport direction of the first roller, the second roller, the third roller, . . . , and the n-th roller, then wrinkles may occur in the medium. However, according to this aspect, the distance has a first distance and a second distance larger than the first distance. As a result, even in a case where a wrinkle has occurred in the medium, due to the second distance, which is a large distance, it is possible to suppress that the wrinkle is concentrated in a portion of the first distance, which is a small distance. Therefore, it is possible to reduce the concern that the medium will crease due to a wrinkle being concentrated in the narrow part of the first distance.

The medium transport device according to a second aspect of the disclosure is an aspect according to the first aspect, further including a winding section that winds the medium transported in the transport direction and a processing section that is disposed between the feed out section and the winding section and that performs a process on the transported medium, wherein the main roller is disposed between the feed out section and the processing section. Here, the “process” in the “processing section that performs a process on the medium” varies depending on the type of device in which the medium transport device is mounted. For example, in a case where the medium transport device is mounted in a recording device such as a printer, the processing section is a recording section having a recording head, and the process is a recording process. In the case of being mounted on a scanner or the like, the processing section serves as an image reading section, and the process is an image reading process.

According to this aspect, a processing section is disposed between the feed out section and the winding section and performs a process on the transported medium.

The main roller is positioned between the feed out section and the processing unit. As a result, when the medium is sent to the processing section and processed, processing by the processing section can be executed in a state in which the occurrence of wrinkles is suppressed.

The medium transport device according to a third aspect of the disclosure is an aspect according to the second aspect, further including a wrinkle removal mechanism that is for removing a wrinkle occurring in the medium being transported and that is disposed between the main roller and the processing section.

According to this aspect, the wrinkle removal mechanism for removing wrinkles that occurred in the transported medium is disposed between the main roller and the processing section. As a result, it is possible to execute processing by the processing section in a state in which the occurrence of the wrinkle is further suppressed by the wrinkle removal mechanism.

The medium transport device according to a fourth aspect of the disclosure is an aspect according to the third aspect, the wrinkle removal mechanism includes a first flat plate and a second flat plate, wherein the first flat plate and the second flat plate are connected by a bent section with an obtuse angle and the medium is transported in contact with an outer surface of the bent section, which is a protruding side of the bent section.

According to this aspect, the medium is transported in contact with the outer surface, which is the protruding side of the bent section in the wrinkle removal mechanism where the first flat plate and the second flat plate are connected to form the bent section with an obtuse angle, thereby removing the wrinkles. As a result, the wrinkle removal mechanism can be realized with a simple structure.

The recording device according to fifth aspect of the disclosure includes a medium transport device of any one of the first to fourth aspects, and a recording section that performs recording on the medium transported by the medium transport device.

According to this aspect, it is possible to obtain the same effect as in any one of the second aspect to the fourth aspect as a recording device.

### Embodiments

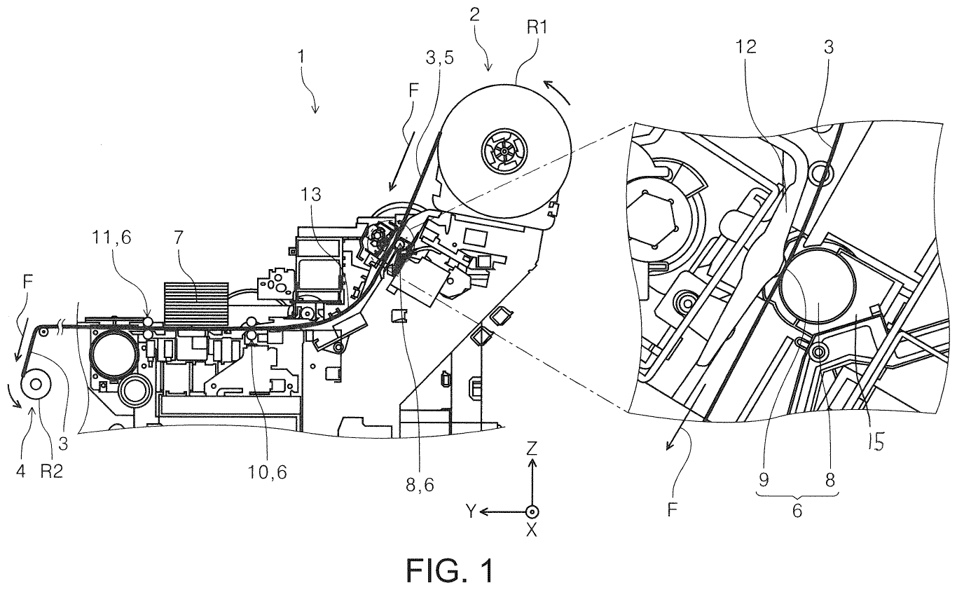

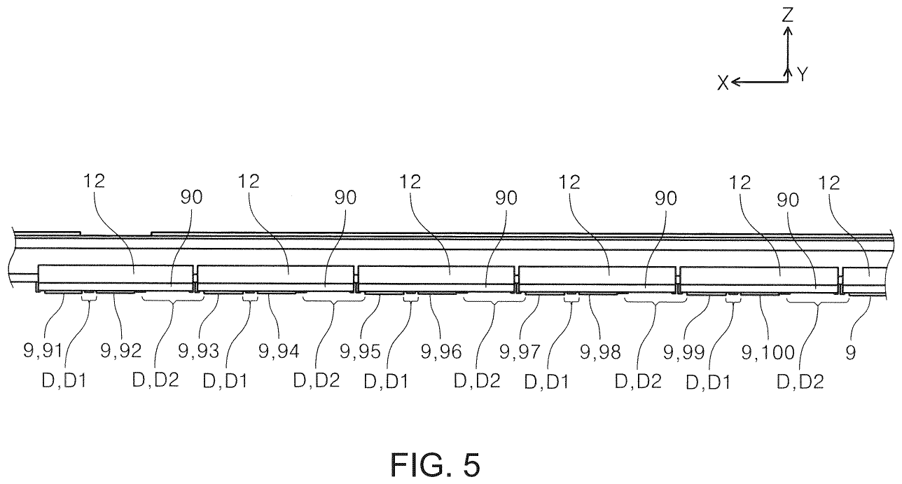

Hereinafter, embodiments of a medium transport device and a recording device equipped with the medium transport device according to the present disclosure will be described with reference to FIGS. 1 to 9.

In the following description, three axes orthogonal to each other are referred to as an X-axis, a Y-axis, and a Z-axis, respectively, as shown in each drawing. The direction indicated by the arrows of the three axes (X, Y, and Z) is the +direction of each direction, and the opposite direction is the −direction. The Z-axis direction corresponds to a vertical direction, that is, a direction in which gravity acts, a +Z direction indicates a vertically upward direction, and a −Z direction indicates a vertically downward direction. The X-axis direction and the Y-axis direction correspond to horizontal directions. The +Y direction indicates the front direction of the recording device, and the −Y direction indicates the rear direction of the device. The +X direction indicates a right direction of the device, and the −X direction indicates a left direction of the device.

### General Overview of the Recording Device

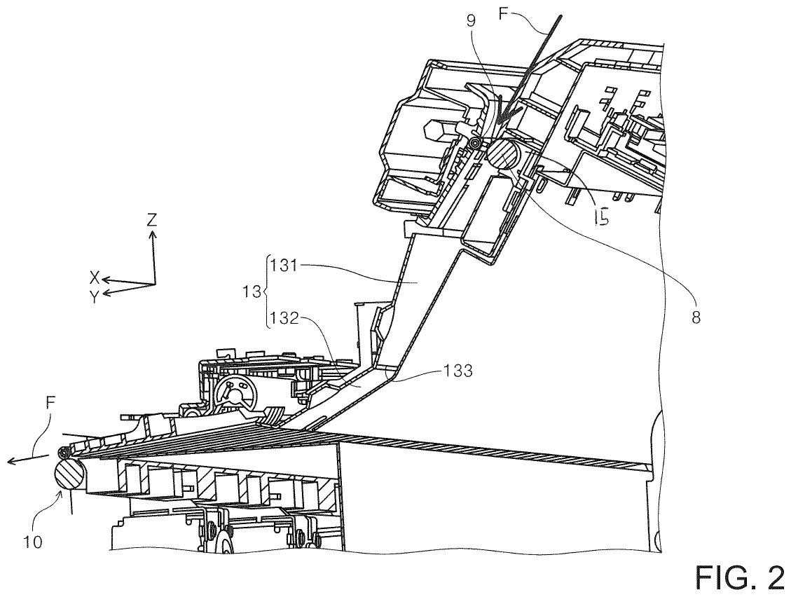

As shown in FIGS. 1 and 2, a recording device 1 of this embodiment is referred to as a digital textile printing machine in which the medium 3 is a fabric. In the recording device 1, an appropriate tension is applied to the fabric by a transport method called a Roll to Reel transport method so that the recording range is in a floating state.

The recording device 1 uses a medium transport device 6 to transport a medium 3 fed from a roll body R1, which is set in a feed out section 2, in transport direction F along a transport path 5. A recording section 7 with a recording head is disposed along the transport path 5. The medium 3 on which a recording process was performed in the recording section 7 is wound onto the roll body R2 of a winding section 4.

As one of the constituent members of the medium transport device 6, a transport roller pair including a main roller 8 and a sub roller 9 is provided at a position closest to the feed out section 2 in the transport path 5. The main roller 8 applies a feeding force to the medium 3 in the transport direction F.

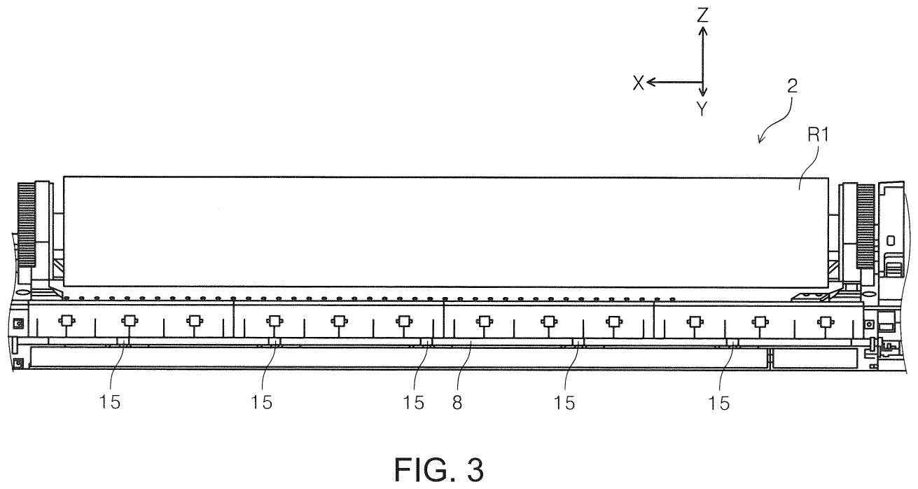

As shown in FIG. 3, the main roller 8 is constituted by one single-body roller, and portions other than the end sections are rotatably supported by intermediary supports 15 so as not to sag downward. In this embodiment, five intermediary supports 15 are disposed at equal distances.

The sub roller 9 pairs with the main roller 8 to rotate while nipping the medium 3.

As other constituent members of the medium transport device 6, an upstream transport roller pair 10 located upstream of the recording section 7 and a downstream transport roller pair 11 located downstream of the recording section 7 are provided.

Next, the medium transport device 6 of the present embodiment will be described in detail, although some of the above description will be repeated.

### First Embodiment

The medium transport device 6 according to a first embodiment will be described with reference to FIGS. 1 to 5.

The medium transport device 6 includes a feed out section 2 that feeds out the medium 3 that is wound in a roll shape, a main roller 8 that applies a feeding force to the medium 3 in the transport direction F, and a sub roller 9 that rotates in a state where the medium 3 is nipped between the sub roller 9 and the main roller 8.

The sub rollers 9 are a plurality of rollers including a first roller 91, a second roller 92, a third roller 93, . . . , and an Nth roller N, which are arranged at a distance D along the X-axis direction, which is the longitudinal direction of the main roller 8, which is a single body. Here, n is an integer of 3 or more.

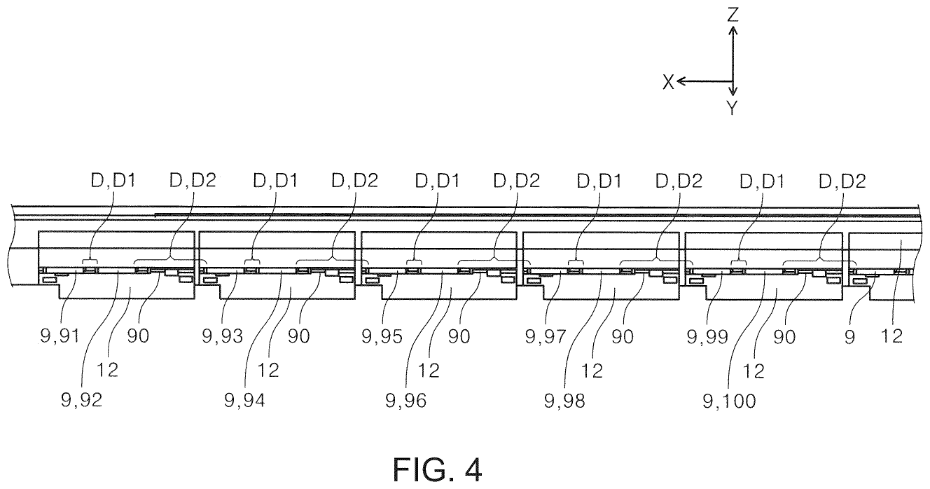

In the example shown in FIGS. 3 and 4, the first roller 91 and the second roller 92 are supported by a single holder 12. A third roller 93 and a fourth roller 94 are supported by another single holder 12. A fifth roller 95 and a sixth roller 96 are supported by another single holder 12. A seventh roller 97 and an eighth roller 98 are supported by a single holder 12. The ninth roller 99 and the tenth roller 100 are supported by another single holder 12. The same applies to the following.

The distance D includes a first distance D1 and a second distance D2 that is larger than the first distance D1. Here, the distance D2 is created by removing one of the sub rollers 9 supported by each of the holders 12. Of course, the present disclosure is not limited to this structure.

For example, a structure may be adopted in which the single holder 12 holds two or three sub rollers 9, and a portion of the distance D1 and a portion of the distance D2 may be formed by separating the holders 12 from each other. The holder 12 may be structured to hold one sub roller 9 to create a portion of the distance D1 and a portion of the distance D2.

The dimension of the second distance D2 is set by grasping in advance, by tests or the like, the state of wrinkles that occur with respect to the assumed medium type.

As shown in FIG. 1 and as described above, the medium transport device 6 of the embodiment includes the winding section 4 that winds the medium 3 transported in the transport direction F, and the recording section 7 that is positioned between the feed out section 2 and the winding section 4 and that serves as a processing section that performs a process on the transported medium 3. The main roller 8 is positioned between the feed out section 2 and the recording section 7.

In the embodiment, as illustrated in FIG. 1, a wrinkle removal mechanism 13 for removing wrinkle that have occurred in the medium 3 being transported is disposed between the main roller 8 and the recording section 7, which is a processing section. As shown in FIG. 2, the wrinkle removal mechanism 13 includes a first flat plate 131 and a second flat plate 132. The first flat plate 131 and the second flat plate 132 are connected to each other at an obtuse-angled bent section 133. As shown in FIG. 1, the medium 3 is transported in contact the outer surface of the bent section 133 that is the protruding side.

### Description of Operation of First Embodiment

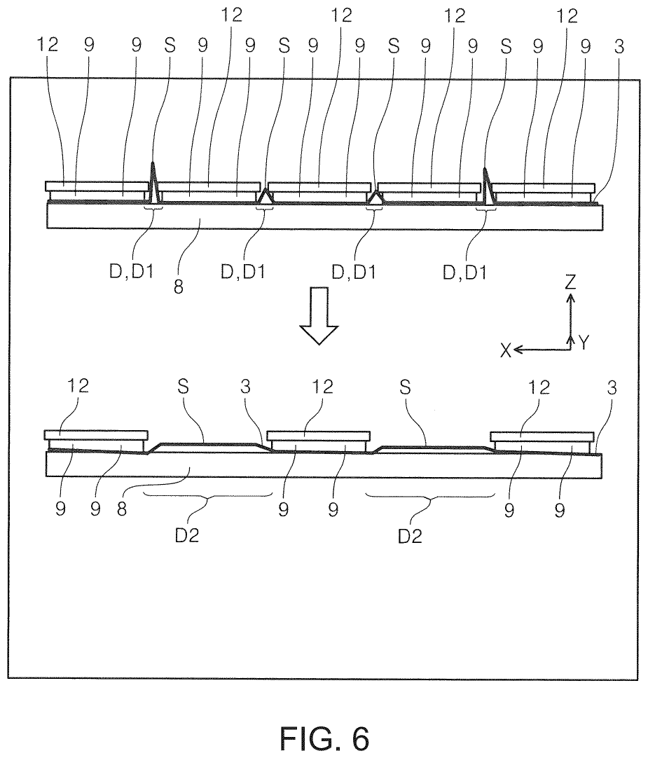

With reference to FIG. 6, a description will be given about the generation of wrinkles by the distance D1 and the distance D2.

In the case where a plurality of sub rollers 9 are disposed at the small distance D1 as shown in the upper position of FIG. 6, wrinkles S that occurred enter the portions of the small distance D1 and are pushed inside by contact with the periphery of a further narrow region, so that the wrinkles S tend to have a pointed shape as shown in the drawing. In such a state, the wrinkle S area is likely to become creased.

On the other hand, in the case as shown in the lower position of FIG. 6 where the plurality of sub rollers 9 are disposed at the distance D2, which is larger than the distance D1, then the wrinkles S enter the portion of the distance D2, but since there is no contact with the periphery, the wrinkles S are only gently bent. Therefore, there is little possibility of creases forming.

### Description of Effects of First Embodiment

(1) The sub rollers 9 are a plurality of rollers including a first roller 91, a second roller 92, a third roller 93, . . . , and an Nth roller N, which are arranged at distance D along the X-axis direction, which is the longitudinal direction of the main roller 8. If there is variation in transporting force and transport direction of the first roller 91, the second roller 92, the third roller 93, and the Nth roller N, then a wrinkle may occur in the medium 3.

However, in this embodiment, the distance D has a first distance D1 and a second distance D2 that is larger than the first distance D1. As a result, even in a case where a wrinkle S has occurred in the medium 3, due to the second distance D2, which is a large distance, it is possible to suppress that the wrinkle S is concentrated in a portion of the first distance D1, which is a small distance. Therefore, it is possible to reduce the concern that the medium 3 will crease due to a wrinkle S being concentrated in the narrow part of the first distance D1.

(2) In this embodiment, the recording section 7, which serves as a processing section that performs a process on the medium 3 being transported, is provided positioned between the feed out section 2 and the winding section 4, and the main roller 8 is positioned between the feed out section 2 and the recording section 7. By this, it is possible to execute the recording process by the recording section 7 in a state in which the occurrence of wrinkles S while the medium 3 is transported to the recording section 7 and subjected to the recording process is suppressed.

(3) In this embodiment, a wrinkle removal mechanism 13 for removing wrinkles that have occurred in the medium 3 being transported is disposed between the main roller 8 and the recording section 7. As a result, it is possible to execute the recording process by the recording section 7 in a state in which the occurrence of wrinkle S is further suppressed by the wrinkle removal mechanism 13.

(4) In this embodiment, the medium 3 is transported in contact with the outer surface of the bent section 133, which is the protruding side of the bent section 133, in the wrinkle removal mechanism 13 where the first flat plate 131 and the second flat plate 132 are connected to form the bent section 133 with an obtuse angle, thereby removing wrinkles S. As a result, the wrinkle removal mechanism 13 can be realized with a simple structure.

### Modification

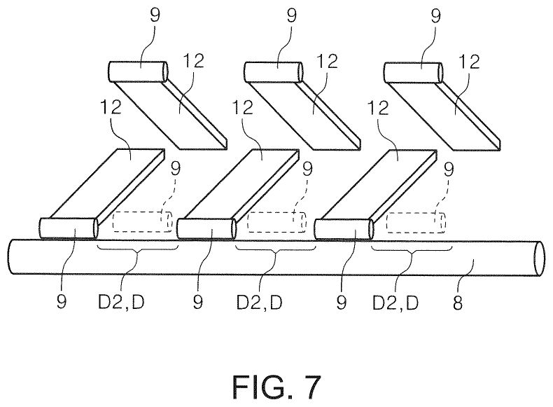

Based on FIG. 7, a modification of the method of providing the second distance D2 will be described. In this modification, the part of the holder 12 that supports a single sub roller 9 is configured to be rotatable with its proximal end, which is at the opposite side than the sub roller 9, as a fulcrum. In the case of a medium 3 in which wrinkles S easily occur, then, as shown in FIG. 7, the rotatable holder 12 can be rotated to form the second distance D2. In the case of a medium 3 in which wrinkles S are less likely to occur, then the rotatable holder 12 is returned to the position where it contacts the main roller 8.

When forming the second distance D2, the rotation angle of the holder 12 may be set such that the sub roller 9 is not largely separated from the main roller 8 as indicated in solid line in FIG. 7 but is slightly separated as indicated in broken line.

### Second Embodiment

Next, a medium transport device 6 according to a second embodiment will be described with reference to FIGS. 1 to 3, 8, and 9. The same parts as those in the first embodiment are denoted by the same reference numerals and description of configuration and the corresponding effects thereof will be omitted.

As shown in FIGS. 1 to 3, although the explanation may be repetitive, the medium transport device 6 of the present embodiment includes the feed out section 2, the main roller 8 formed of a single body, and the plurality of sub rollers 9 arranged at the distance D along the X-axis direction, which is the longitudinal direction of the main roller 8.

In the present embodiment, each distance D is of the same size, but as in the first embodiment may include a first distance D1 and a second distance D2. The plurality of sub rollers 9 rotate while nipping the medium 3 paired with the main roller 8, thereby transporting the medium 3.

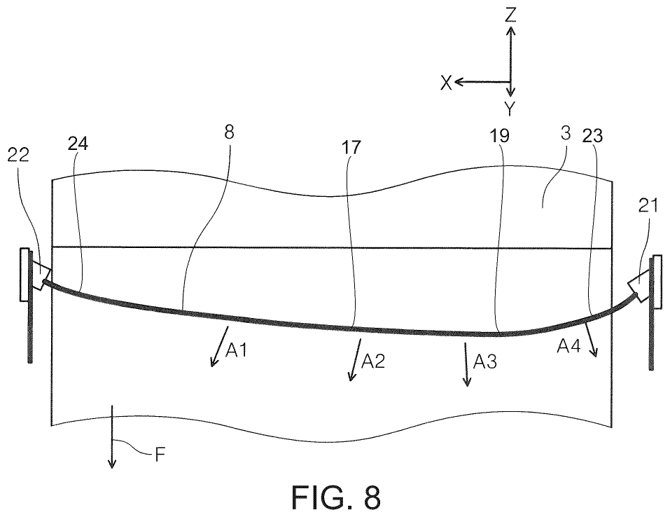

As shown in FIG. 8, in the present embodiment, the intermediate section 17 in the longitudinal direction of the main roller 8 is disposed at the downstream side in the transport direction F with respect to both end sections 23 and 24. That is, the main roller 8 is mounted in a slightly arched shape.

In FIG. 3, the shape is not an arched shape but a linear shape because the arched shape is a deformation that cannot be confirmed by the human eye.

In FIG. 8, the degree of arching of the main roller 8 is exaggerated in order to make it easier to understand that the main roller 8 has an arched shape.

As shown in FIG. 8, the arched shape of the main roller 8 is realized by tilting the first bearing 21 and the second bearing 22, which axially support both of the end sections 23 and 24 of the main roller 8. The state of the arched shape deformation is determined by the inclination direction and angle of the first bearing 21 and the second bearing 22.

As a result, the intermediate section 17 of the main roller 8 is disposed at the downstream side in the transport direction F with respect to both end sections 23 and 24.

As shown in FIG. 3, in the present embodiment, a plurality of intermediary supports 15 are provided that support the main roller 8 so as to be rotatable. The plurality of intermediary supports 15 arranged in the intermediate section 17 in the X-axis direction, which is the longitudinal direction, are disposed downstream in the transport direction F from those disposed at the end section 23 and 24 sides in the longitudinal direction. In FIG. 3, since the main roller 8 is depicted in a linear shape, the multiple intermediary supports 15 are also arranged in a straight line. In the present embodiment, the plurality of intermediary supports 15 are configured to be displaced and positionally adjusted in the transport direction F.

As described above, the arched shape of the main roller 8 shown in FIG. 8 is exaggerated. In FIG. 8, the plurality of intermediary supports 15 are arranged along the arched shape of the main roller 8, although not shown.

In the present embodiment, the inclination angle of the first bearing 21 is set to be larger than the inclination angle of the second bearing 22. That is, the main roller 8 is axially supported in a state in which the first bearing 21 side is bent more than the second bearing 22 side.

As a result, as shown in FIG. 8, a portion 19 of the intermediate section 17 of the main roller 8, which is located at the most downstream position in the transport direction F, is formed in an arched shape that makes it close to the first bearing 21.

By this, among the plurality of intermediary supports 15, the intermediary support 15 that is disposed at the most downstream position in the transport direction F is located at a position close to the first bearing 21, which is on one end side in the longitudinal direction of the main roller 8.

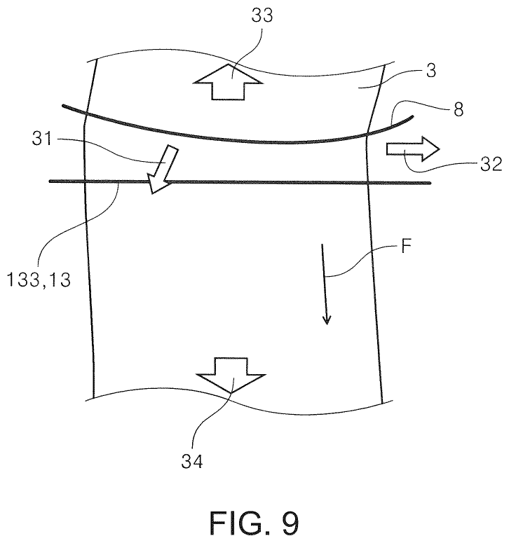

As shown in FIG. 9, in this embodiment, the medium 3 being transported is applied with tension 33 and 34 between the winding section 4 and the feed out section 2. The tension 33 and 34 is generated by setting the winding speed of the winding section 4 to be slightly faster than the feed out speed of the feed out section 2, but the method of applying tension is not limited to a specific method.

In the embodiment, since the wrinkle removal mechanism 13 is provided as described above, the occurrence of wrinkles is suppressed by a synergistic effect with the wrinkle removal mechanism 13.

### Description of Operation of Second Embodiment

With reference to FIG. 8, a description will be given suppression of the occurrence of wrinkles by the arched shape of the main roller 8.

In the present embodiment, the direction of the feeding force that is applied to the medium 3 from the main roller 8 acts in a direction that spreads and flattens the wrinkles that have occurred as a whole, as indicated by arrow A1, arrow A2, arrow A3, and arrow A4, due to the arched shape of the main roller 8.

When the medium 3 with a small width is positioned and set at the reference position on the first bearing 21 side, as indicated by arrows A2, A3, and A4, it acts as a whole in the direction of spreading and flattening wrinkles that occurred.

As shown in FIG. 9, a medium 3 with a small width is likely to skew due to the feeding force from main roller 8 as indicated by arrow 31. In the present embodiment, even in this case, as indicated by arrow 32, tension 33, 34 generates a force in the direction of correcting the skew. As a result, it is possible to suppress the occurrence of wrinkle and skew.

### Description of Effects of Second Embodiment

(1) In the present embodiment, the main roller 8 and the sub roller 9 are provided, and the intermediate section 17 in the X-axis direction, which is the longitudinal direction of the main roller 8, is disposed at a position on the downstream side in the transport direction F with respect to the end sections 23 and 24. That is, the main roller 8 is mounted in a slightly arched shape. As a result, since the transport force acts on the medium 3 being transported at a slant in a direction in which wrinkles S are removed from the main roller 8, that is, in a direction in which the occurred wrinkle S is spread and flattened, it is possible to easily suppress the occurrence of wrinkle S in the transport of medium 3 having low rigidity such as fabric.

(2) In the present embodiment, the intermediary support 15 that is disposed at the intermediate section 17 in the X-axis direction, which is the longitudinal direction, is disposed at a downstream position in the transport direction F from the intermediary supports 15 that are disposed at the end section 23 and 24 sides in the longitudinal direction. That is, the plurality of intermediary supports 15 are arranged in the longitudinal direction along the arched shape of the main roller 8. As a result, it is possible to prevent the main roller 8 from descending due to gravity.

(3) In a case where the medium transport device 6 transports medium 3 of different widths, the reference position for positioning in the X-axis direction, which is the width direction of medium 3 with respect to the medium transport device 6, may be set to a position on one end side in the width direction, rather than the center position in the width direction. In this case, the main roller 8 comes into contact with medium 3 at a part of the one end side.

In the present embodiment, among the plurality of intermediary supports 15, the intermediary support 15 disposed at the most downstream position in the transport direction F is the intermediary support disposed at a position on one end side in the X-axis direction, which is the longitudinal direction of the main roller 8, here, the intermediary support on the first bearing 21 side. As a result, even for a medium 3 with a small width, the transporting force can be inclined to act in a direction that spreads and flattens the wrinkle S is occurred by the main roller 8, thereby it is possible to suppress the occurrence of wrinkles S.

(4) In the present embodiment, the plurality of intermediary supports 15 can be displaced and positionally adjusted in the transport direction F. As a result, the degree of the arched shape of the main roller 8 can be changed in accordance with the type of medium 3.

(5) In the embodiment, the recording section 7 is disposed between the feed out section 2 and the winding section 4 and is provided as a processing section that performs a process on the medium 3 being transported, and the main roller 8 is disposed between the feed out section 2 and the recording section 7. By this, it is possible to execute the recording process by the recording section 7 in a state in which the occurrence of wrinkles S while the medium 3 is transported to the recording section 7 and subjected to the recording process is suppressed.

(6) Furthermore, in this embodiment, a wrinkle removal mechanism 13 is arranged between the main roller 8 and the recording section 7 to remove the wrinkle S that occurs in the medium 3 being transported. As a result, it is possible to execute the recording process by the recording section 7 in a state in which the occurrence of wrinkle S is further suppressed by the wrinkle removal mechanism 13.

(7) In this embodiment, wrinkles are removed by medium 3 being transported in contact with the outer surface of the bent section, which is the protruding side of the bent section, in the wrinkle removal mechanism where the first flat plate and the second flat plate are connected to form a bent section with an obtuse angle. As a result, the wrinkle removal mechanism can be realized with a simple structure.

(8) In the embodiment, tension 33 and 34 is applied to medium 3 being transported between winding section 4 and feed out section 2. As a result, it is possible to further suppress the occurrence of wrinkles S by a synergistic effect with the wrinkle removal mechanism 13.

### OTHER EMBODIMENTS

The recording device 1 according to the disclosure basically has the configuration of the embodiment described above, but it is of course possible to change or omit parts of the configuration without departing from the gist of the disclosure of the present application.

In the above embodiment, the arched shape of the main roller 8 is not symmetrical in the width direction and is shifted to the first bearing 21 side. However, when the reference position for alignment is the center, it is preferable to have the arched shape symmetrical.

What is claimed is:

1. A medium transport device comprising:
a feed out section that feeds out a medium that is wound into a roll shape;
a main roller that applies a feeding force to the medium in a transport direction; and
sub rollers that pair with the main roller to rotate while nipping the medium therebetween, wherein
the sub rollers are a plurality of rollers including a first roller, a second roller, a third roller, . . . , and an n-th roller arranged at distances from each other along the longitudinal direction of the main roller, n being an integer equal to or larger than 3, and
the distances include
a first distance and
a second distance that is larger than the first distance.

2. The medium transport device according to claim 1, further comprising:
a winding section that winds the medium transported in the transport direction and
a processing section that is positioned between the feed out section and the winding section and that performs a process on the transported medium, wherein
the main roller is disposed between the feed out section and the processing section.

3. The medium transport device according to claim 2, further comprising:
a wrinkle removal mechanism that is for removing a wrinkle occurring in the medium being transported and that is disposed between the main roller and the processing section.

4. The medium transport device according to claim 3, wherein
the wrinkle removal mechanism includes a first flat plate and a second flat plate,
the first flat plate and the second flat plate are connected to form a bent section with an obtuse angle, and
the medium is transported in contact with an outer surface of the bent section, which is a protruding side of the bent section.

5. A recording device comprising:
the medium transport device according to claim 1 and
a recording section that performs recording on the medium transported by the medium transport device.
